(19) United States
(12) Patent Application Publication
(10) Pub. No.: US 2014/0260698 A1
(43) Pub. Date: Sep. 18, 2014

(54) Transparent Liquid Suction Measuring Device

(71) Applicant: TAICHUNG VETERANS GENERAL HOSPITAL, Taichung City (TW)

(72) Inventor: Ming-Feng WU, Taichung City (TW)

(73) Assignee: TAICHUNG VETERANS GENERAL HOSPITAL, Taichung City (TW)

(21) Appl. No.: 13/797,456

(22) Filed: Mar. 12, 2013

(51) Int. Cl. B01L 3/02

(52) U.S. Cl. CPC B01L 3/021
USPC 73/864.11

(57) ABSTRACT

A transparent liquid suction measuring device comprises a conduit portion, a main body, and a suction generating portion. Liquid can be sucked into the main body via the conduit portion. The main body comprises a chamber to accommodate the liquid. The chamber has many inward projecting elements, a corresponding area, and many outward projecting elements. The inward projecting elements occupy an inward projecting volume that is compensated by an outward projecting volume formed by the outward projecting elements. So, an accommodating volume of the chamber is constantly maintained. When the inward projecting elements are visually observing from a corresponding area through the chamber, magnifying effect is generated. These outward projecting elements can be observed to acquire the liquid volume. Therefore, the advantages includes magnifying scales through liquid lens effects, having a compensation design to maintain measuring accuracy, and having a rough structure to make scales much visually obvious.

### TECHNICAL FIELD

The present invention relates to a transparent liquid suction measuring device, and especially to a transparent liquid suction measuring device having advantages of magnifying scales by applying liquid lens effects, and of having a compensation design to maintain measuring accuracy and a rough structure to make the scales more obviously viewable.

### DESCRIPTION OF BACKGROUND

Referring to FIGS. 10-11, a conventional liquid suction measuring device (such as a dropper) is shown. The liquid suction measuring device 80 comprises a conduit portion 81, a main body 82 and a suction bulb portion 83 all of which are substantially interconnected and communicated with one another.

The conduit portion 81 comprises an opening 811 used for suction.

The main body 82 comprises a chamber 821, and a plurality of scale indicators 822 disposed outside the chamber 821 and linearly and evenly distributed between the conduit portion 81 and the suction bulb portion 83.

The suction bulb portion 83 is used to enable the conduit portion 81 generating suction forces when the suction bulb portion 83 is transformed between being squeezed and released (Referring also to action processes as shown in FIGS. 5-6, although their numeric labels are different, their action principles are considered to be same).

Therefore, when liquid 91 is accommodated in the chamber 821, a stored volume of the liquid 91 can be measured through the scale indicators 822.

Generally, a measuring device is a structure close to being transparent in order to observe color and volume of its content. However, the scale indicators 822 are quite small and tiny. A result of visual measuring is still clear if the liquid 91 is colored. Nevertheless, clearness of visual measuring is hindered if the liquid 91 is colorless. Certainly, the scale indicators 822 can be further colorized through additional manufacturing procedures (more troublesome), or they can be observed via a magnifying glass. However, it is inconvenient to additionally hold a magnifying glass during processes of liquid suctioning and measuring.

Although U.S. Pat. No. 2,303,154 discloses a liquid accommodating device with a scaling function design, the device does not comprise a structure of compensating stored volumes and cannot be used in any field requiring precision measurement.

Accordingly, it is necessary to research and develop techniques to solve the above-mentioned shortcomings.

### SUMMARY

An object of the present invention is to provide a transparent liquid suction measuring device having advantages of magnifying scales by applying liquid lens effects, and of having a compensation design to maintain measuring accuracy and a rough structure to make the scales more obviously viewable. Particularly, the present invention is to solve the current problem including the shortcoming that there is no transparent liquid suction measuring device in the market which can directly magnify scales by applying liquid lens effects and has a compensation structure.

To achieve the above objects, the present invention provides a transparent liquid suction measuring device. The transparent liquid suction measuring device comprises a conduit portion, a main body and a suction generating portion all of which are substantially interconnected and communicated with one another.

The conduit portion used for suction comprises an opening.

The main body comprises a chamber, a plurality of inward projecting elements, a corresponding area and a plurality of outward projecting elements. The chamber comprises an outer surface and an inner surface. The plurality of inward projecting elements are disposed at the chamber, and are substantially linearly and evenly distributed between the conduit portion and the suction generating portion. Each of the plurality of inward projecting elements extrudes inwards from the inner surface into an inner of the chamber and has an inward projecting volume therein.

The corresponding area is located at the chamber and is substantially opposite to each of the plurality of inward projecting elements.

The plurality of outward projecting elements are disposed at the chamber, and are located outside the corresponding area to respectively correspond to the plurality of the inward projecting elements. Each of the plurality of outward projecting elements extrudes outwards along a direction from the inner surface toward the outer surface, and has an outward projecting volume therein which is same as the inward projecting volume.

The suction generating portion is used to enable the conduit portion generating a suction force when the suction generating portion is transformed between being squeezed and being released.

Therefore, when the chamber is used for accommodating liquid having a stored volume thereof, the outward projecting volume is used to compensate the corresponding inward projecting volume so as to maintain constancy of the stored volume. Either one of the plurality of inward projecting elements is visually magnified to an enlarged image status along a direction toward the corresponding area as viewed at the corresponding area through the chamber according to applying the liquid lens principle so as to facilitate measuring the stored volume.

### DESCRIPTION OF THE DRAWINGS

FIG. 1 is a schematic perspective view of a transparent liquid suction measuring device in accordance with an embodiment of the present invention.

FIG. 2 is a partially cross-sectional perspective view of FIG. 1.

FIG. 3 is a cross-sectional view taken along the line III-III in FIG. 2.

FIG. 4A is a cross-sectional view taken along the line IV-IV in FIG. 2 showing a first embodiment of locations of inward projecting elements and outward projecting elements corresponding to a chamber of the present invention.

FIG. 4B is a cross-sectional view taken along the line IV-IV in FIG. 2 showing a second embodiment of locations of the inward projecting elements and outward projecting elements corresponding to the chamber of the present invention.

FIG. 5 is a schematic cross-sectional view of squeezing a suction generating portion of the present invention.

FIG. 6 is a schematic cross-sectional view of releasing the suction generating portion of the present invention.

FIG. 7 is a schematic partial perspective view of the chamber accommodating liquid.

FIG. 8A is a schematic partial cross-sectional view showing the inner projecting elements being visually observed from a corresponding area of the present invention and an enlarged image status thereof being viewed.

FIG. 8B is a schematic partial cross-sectional view showing the outer projecting elements being visually observed and a normal image status thereof being viewed.

FIG. 9A is a transversal cross-sectional view of FIG. 8A.

FIG. 9B is a transversal cross-sectional view of FIG. 8B.

FIG. 10 is a schematic perspective view of a conventional device.

FIG. 11 is a schematic cross-sectional view of the conventional device of FIG. 10.

### DETAILED DESCRIPTION OF THE EMBODIMENTS

Referring to FIGS. 1-4A, a transparent liquid suction measuring device is provided in accordance with an embodiment of the present invention. The transparent liquid suction measuring device 10 comprises a conduit portion 11, a main body 12 and a suction generating portion 13 all of which are substantially interconnected and communicated with one another.

Among them, the conduit portion 11 used for suction comprises an opening 111.

The main body 12 comprises a chamber 121 having an outer surface 12A and an inner surface 12B, a plurality of inward projecting elements 122, a corresponding area 123 and a plurality of outward projecting elements 124.

The plurality of inward projecting elements 122 are disposed at the chamber 121, and are linearly and evenly distributed between the conduit portion 11 and the suction generating portion 13. Each of the plurality of inward projecting elements 122 extrudes inwards from the inner surface 12B into an inner of the chamber 121 and has an inward projecting volume V1.

The corresponding area 123 is located at the chamber 121 (referring to FIG. 4A) and is substantially opposite to each of the plurality of inward projecting elements 122.

The plurality of outward projecting elements 124 are disposed at the chamber 121 and are located outside the corresponding area 123 to respectively correspond to the plurality of inward projecting elements 122. Each of the plurality of outward projecting elements 124 extrudes outwards along a direction from the inner surface 12B toward the outer surface 12A, and has an outward projecting volume V2 which is same as the inward projecting volume V1.

The suction generating portion 13 is used to enable the conduit portion 11 generating a suction force when the suction generating portion 13 is transformed between being squeezed (such as being held by fingers and squeezed as shown in FIG. 5) and being released (such as held by fingers without being squeezed as shown in FIG. 6).

Therefore, when the chamber 121 is used for accommodating liquid 91 having a stored volume V3, the outward projecting volume V2 is used to compensate the corresponding inward projecting volume V1 so as to maintain constancy of the stored volume V3. Either one of the plurality of inward projecting elements 122 is visually magnified to an enlarged image status P1 (as shown in FIGS. 8A and 9A) along a direction toward the corresponding area 123 as viewed at the corresponding area 123 through the chamber 121 according to applying of the liquid lens principle so as to facilitate measuring the stored volume V3.

Practically, referring to FIG. 4B, each of the plurality of inward projecting elements 122 extrudes inwards along a direction from the outer surface 12A toward the inner surface 12B (as a second embodiment), and also has the inward projecting volume V1 in order to save used material during injection molding.

The suction generating portion 13 is a flexible structure (such as soft elastic plastics) to be squeezable (being able to be manually squeezed or to be automatically squeezed through connections with electrical or mechanism structures), and to be restorable to an original shape thereof after being squeezed. When the conduit portion 11, the chamber 12 and the suction generating portion 13 are made as an integral injection-molding structure, all of them are made to be flexible structures. Certainly, the conduit portion 11 and the chamber 12 can also be made via a same manufacturing procedure (such as using transparent glass tubes), and then be additionally assembled with the suction generating portion 13 to finalize the measuring device of the present invention.

The outer surface 12A and the inner surface 12B are substantially transparent surfaces.

The plurality of inward projecting elements 122 are integrally formed with the chamber 121.

Each of the plurality of inward projecting elements 122 is at least a kind of a symbolic structure, a numeric structure, or a scale structure.

Each of the plurality of inward projecting elements 122 comprises an inward projecting inner face 12C (Referring to the related bold black line as shown in FIGS. 4A-4B) and an inward projecting outer face 12D (Referring to the related bold black line as shown in FIGS. 4A-4B). The inward projecting inner and outer faces 12C, 12D are respectively disposed at the inner surface 12B and the outer surface 12A. At least one of the inward projecting inner face 12C and the inward projecting outer face 12D is substantially a rough surface structure (also can be a matte finished surface or any structure that can result in scattering of light). When the inward projecting inner face 12C and the inward projecting outer face 12D are both rough surfaces, measuring effects can be presented conspicuously.

The plurality of outward projecting elements 124 are integrally formed with the chamber 121.

Each of the plurality of outward projecting elements 124 is at least a kind of a symbolic structure, a numeric structure, or a scale structure.

Each of the plurality of outward projecting elements 124 comprises an outward projecting inner face 12E (Referring to the related bold black line as shown in FIGS. 4A-4B) and an outward projecting outer face 12F (Referring to the related bold black line as shown in FIGS. 4A-4B). The outward projecting inner and outer faces 12E, 12F are respectively located at the inner surface 12B and the outer surface 12A. At least one of the outward projecting inner face 12E and the outward projecting outer face 12F is substantially a rough surface structure (or can be a matte finished surface or any surface structure that can result in scattering of light). When the outward projecting inner face 12E and the outward projecting outer face 12F are both rough surfaces, measuring effects can be presented conspicuously.

Particularly, when the liquid 91 is opaque (or colored) liquid, the plurality of outward projecting elements are able to assist instant visual measuring directly from the outer surface 12A of the chamber 121.

It is required to particularly explain that the so-called liquid lens principle means utilizing liquid as a lens. By changing a curvature of the liquid, a focal length of the liquid is altered (For example an object to be viewed will be visually magnified through a conventional polyethylene terephthalate (PET) bottle filled with water).

Usages of the present invention are described as following.

The transparent liquid suction measuring device 10 is firstly held to inset the opening 111 of the conduit portion 11 into the liquid 91. Afterwards, actions to squeeze (as shown in FIG. 5) and release (as shown in FIG. 6) the suction generating portion 13 are adopted (A quantity of the liquid 91 is adjustable through repeatedly proceeding the actions, this is a well known extracting liquid principle of a dropper, and therefore, details thereof are unnecessary to provide here) to suck the liquid 91 from the opening 111 into the chamber 121 through the conduit portion 11 (as shown in FIG. 7).

Referring to FIGS. 8A and 9A, when the main body 12 is visually observed from the corresponding area 123, an enlarged image status P1 of either one of the plurality of inward projecting elements 122 (at least enlarged twice as shown in FIG. 8A) can be viewed by applying the liquid lens principle if the liquid 91 is accommodated at the viewing positions. Therefore, a sucked quantity of the liquid 91 can be measured through the plurality of inward projection elements 122. If at least one of the inward projecting inner face 12C and the inward projecting outer face 12D is a rough surface (or a matte finished surface), the visual scale to be observed is much more obvious.

Referring to FIGS. 8B and 9B, since the chamber 121 is a through-viewable structure, the sucked quantity of the liquid 91 is still measurable through the plurality of outward projecting elements 124 even if the main body 12 is visually observed from the plurality of outward projecting elements 124. The only difference between the current observing way and the above mentioned observing way is that the plurality of outward projecting elements 124 will be observed as a normal image status P2 without magnifying effects. When the liquid 91 is colored, its measuring effect is much more obvious.

The advantages and effects of the present invention can be concluded as following.

[1] Magnifying scales through liquid lens effects: The present invention comprises the plurality of inward projecting elements 122 disposed at the chamber and the corresponding area 123 for visually observation. When the plurality of inward projecting elements 122 are visually observed from the corresponding area 123 through the chamber 121, the plurality of inward projecting elements 122 (i.e., scales) can be magnified by applying the liquid lens principle as long as the liquid 91 is accommodated in the observing positions. Clearness of measuring liquid volumes is hence enhanced. Therefore, scales can be magnified by applying the liquid lens principle.

[2] Providing a compensation design to maintain measuring accuracy: The plurality of inward projecting elements 122 protrude inwardly into the chamber 121. Although the inward projecting volume V1 thereof occupies the stored volume V3 of the liquid 91, the outward projecting volume V2 of each of the plurality of outward projecting elements 124 is designed to be same as the inward projecting volume V1 and is available for accommodating the liquid 91 so as to compensate the stored volume V3 of the liquid 91 occupied by the inward projecting volume V1. Therefore, the present invention provides a compensation design to maintain measuring accuracy.

[3] Providing a rough structure to make scales more obviously viewable: At least one of the inward projecting inner face 12C and the inward projecting outer face 12D is a rough structure so as to strengthen visual effects of outlines of the plurality of inward projecting elements 122. In addition, since no pigment is used, the liquid 91 is prevented from chemical changes after a chemical action is generated between the pigment and the liquid. Therefore, the scales can be much more visually obvious due to the rough structure.

[4] Convenience of double measuring designs: When the liquid 91 to be sucked is transparent and colorless, measurement can be proceeded by observing the enlarged image of the plurality of inward projecting elements 122 by applying the liquid lens principle (i.e., the first measuring design). When the liquid 91 to be sucked is colored, measurement can be proceeded by directly observing the plurality of outward projecting elements 124 (i.e., the second measuring design). Therefore, it is convenient to have the double measuring designs.

The above mentioned is only exemplary embodiments of the present invention. It should be noted, for persons of ordinary skill in this art field, improvements and modifications within the spirit of the present invention can be further made, and such improvements and modifications should be seemed to be included in the claimed scope of the present invention.

What is claimed is:

1. A transparent liquid suction measuring device comprising a conduit portion, a main body and a suction generating portion all of which are interconnected and communicated with one another;
wherein the conduit portion used for suction comprises an opening;
the main body comprises:
a chamber having an outer surface and an inner surface;
a plurality of inward projecting elements being disposed at the chamber, and linearly and evenly distributed between the conduit portion and the suction generating portion, each of the plurality of inward projecting elements extruding inwards from the inner surface into an inner of the chamber and having an inward projecting volume therein;
a corresponding area being located at the chamber and being opposite to each of the plurality of inward projecting elements; and
a plurality of outward projecting elements being disposed at the chamber, and being located outside the corresponding area to respectively correspond to the plurality of inward projecting elements, each of the plurality of outward projecting elements extruding outwards along a direction from the inner surface toward the outer surface, and having an outward projecting volume therein which is same as the inward projecting volume;
the suction generating portion is used to enable the conduit portion generating a suction force when the suction generating portion is transformed between being squeezed and being released; and
when the chamber is used for accommodating liquid having a stored volume thereof, the outward projecting volume is used to compensate the corresponding inward projecting volume so as to maintain constancy of the stored volume, either one of the plurality of inward projecting elements is visually magnified to an enlarged image status along a direction toward the corresponding area as viewed at the corresponding area through the chamber according to applying of the liquid lens principle in order to facilitate measuring the stored volume.

2. The transparent liquid suction measuring device as claimed in claim 1, wherein:
each of the plurality of inward projecting elements extrudes inwards along a direction from the outer surface toward the inner surface, and has the inward projecting volume therein; and
the outer surface and the inner surface are through-viewable surfaces.

3. The transparent liquid suction measuring device as claimed in claim 1, wherein each of the plurality of inward projecting elements is integrally formed with the chamber.

4. The transparent liquid suction measuring device as claimed in claim 1, wherein each of the plurality of inward projecting elements is at least a kind of a symbolic structure, a numeric structure, or a scale structure.

5. The transparent liquid suction measuring device as claimed in claim 1, wherein:
each of the plurality of inward projecting elements comprises an inward projecting inner face and an inward projecting outer face, the inward projecting inner and outer faces are respectively located at the inner surface and the outer surface; and
at least one of the inward projecting inner face and the inward projecting outer face is a rough surface structure.

6. The transparent liquid suction measuring device as claimed in claim 1, wherein each of the plurality of outward projecting elements is integrally formed with the chamber.

7. The transparent liquid suction measuring device as claimed in claim 1, wherein each of the plurality of outward projecting elements is at least a kind of a symbolic structure, a numeric structure, or a scale structure.

8. The transparent liquid suction measuring device as claimed in claim 1, wherein:
each of the plurality of outward projecting elements comprises an outward projecting inner face and an outward projecting outer face, the outward projecting inner and outer faces are respectively located at the inner surface and the outer surface; and
at least one of the outward projecting inner face and the outward projecting outer face is a rough surface structure.

9. The transparent liquid suction measuring device as claimed in claim 1, wherein:
the suction generating portion is a flexible structure to be squeezable and restorable to an original shape thereof after being squeezed; and
when the conduit portion, the chamber and the suction generating portion are made as an integrally injection molding structure, all of the conduit portion, the chamber and the suction generating portion are flexible structures.

10. The transparent liquid suction measuring device as claimed in claim 1, wherein:
the suction generating portion is a flexible structure to be squeezable and restorable to an original shape thereof after being squeezed; and
the conduit portion and the chamber are an integrally formed structure, and are connectively assembled with the suction generating portion.
